(19) United States
(12) Patent Application Publication
(10) Pub. No.: US 2009/0305882 A1
(43) Pub. Date: Dec. 10, 2009

(54) Articles Comprising Tetragonal Zirconia and Methods of Making the Same

(75) Inventors: Stephen Dahar, Solon, OH (US); Mure Te, Waltham, MA (US)

Correspondence Address: SAINT-GOBAIN NORPRO, 3840 FISHCREEK ROAD, STOW, OH, 44224, US

(73) Assignee: Saint-Gobain Ceramics & Plastics, Inc., Worcester, MA (US)

(21) Appl. No.: 12/162,808

(22) PCT Filed: Feb. 1, 2007
(86) PCT No.: PCT/US07/02999

§ 371 Date: Oct. 14, 2008

Related U.S. Application Data
(60) Provisional application No. 60/764,909, filed on Feb. 3, 2006.

(51) Int. Cl. B01J 23/10; C01G 25/02; C04B 38/00; B01J 23/02; B01J 23/04; B01J 23/08; B01J 23/40; B01J 23/70; B01J 23/14

(52) U.S. Cl. 502/303; 423/608; 501/80; 502/340; 502/344; 502/355; 502/325; 502/352; 428/402

(57) ABSTRACT

Described is a porous ceramic body comprising zirconia having mesopores incorporated therein and the primary crystalline phase is tetragonal. When used as a carrier for a catalyst, the porous ceramic body has excellent crush resistance and a large total pore volume which results in an increase in the carrier's surface area onto which catalytic material may be deposited. Methods of making the carrier are also disclosed.

### BACKGROUND OF THE INVENTION

This invention relates to a formed, porous ceramic body and the process for making the body. More particularly, this invention pertains to a catalyst carrier made from zirconia.

Previous attempts to manufacture articles from zirconia are disclosed in the following patent and published international patent applications. U.S. Pat. No. 5,269,990,entitled Preparation of Shaped Zirconia Particles, describes a method of making shaped zirconia particles by mixing zirconia powder with an aqueous colloidal zirconia solution or an aqueous acid solution so as to obtain a shapable mixture containing about 4-40 weight % water, shaping the mixture, and heating the shaped particles at a temperature in excess of about 90° C. WO 94/08914, entitled Shaped Articles of Zirconia, discloses a method of making a shaped green body that is suitable for firing to form a zirconia based article of a desired shape. The process includes mixing zirconium hydroxide and at least one binder that comprises a different zirconium compound which is thermally decomposable to zirconia. WO 2004/065002, entitled Zirconia Extrudates, is directed to a process for preparing calcined zirconia extrudate. The particulate zirconia comprises no more than 15% by weight of zirconia which is other than monoclinic zirconia.

### BRIEF SUMMARY OF THE INVENTION

The inventors have discovered that porous ceramic bodies manufactured using zirconium hydroxide powder having certain physical characteristics may be used to produce carrier for catalytically active material typically used in chemical processes to facilitate or enhance desirable reactions. The ceramic bodies are resistant to crushing, thermally stable at high temperatures and have mesopores incorporated therein.

In one embodiment, this invention may be a formed, porous ceramic body made of zirconia and having a crush strength greater than 3.0 kg when tested as a 3 mm pellet, a pore size distribution having at least one major mode which peaks between 5 nm and 50 nm, and the zirconia's primary crystalline phase is tetragonal.

In another embodiment, this invention may be a process for making porous ceramic bodies made of zirconia. The process comprises the following steps. Providing a zirconium hydroxide powder having an amorphous structure, a surface area of at least 300 m²/g, and average pore size between 5 nm and 15 nm. Providing a liquid and one or more additives selected from the group consisting of at least one binder, an extrusion agent, a stabilizing agent, and at least one dispersant. Mixing the zirconium hydroxide powder with the liquid and at least one of the additives to form a manually deformable mass. Forming the deformable mass into a plurality of discreet bodies. Then sintering the bodies at a sufficient temperature for a sufficient period of time to produce ceramic bodies having an average crush strength greater than 3.0 kg when tested as a 3 mm pellet, a pore size distribution having at least one major mode which peaks between 5 nm and 50 nm, and the zirconia's primary crystalline phase is tetragonal.

In yet another embodiment, this invention may be a process for making porous ceramic bodies made of zirconia. The process comprises the following steps. Providing a zirconium hydroxide powder comprising a stabilizing agent and having an amorphous structure, a surface area of at least 300 m²/g, and average pore size between 5 nm and 15 nm. Providing a liquid and one or more additives selected from the group consisting of at least one binder, an extrusion agent, and at least one dispersant. Mixing the zirconium hydroxide powder with the liquid and at least one of the additives to form a manually deformable mass. Forming the deformable mass into a plurality of discreet bodies. Then sintering the bodies at a sufficient temperature for a sufficient period of time to produce ceramic bodies having an average crush strength greater than 3.0 kg when tested as a 3 mm pellet, a pore size distribution having at least one major mode which peaks between 5 nm and 50 nm, and the zirconia's primary crystalline phase is tetragonal.

### BRIEF DESCRIPTION OF THE DRAWINGS

FIG. 1 discloses shapes of bodies that may be manufactured by a process of this invention;

FIG. 2 shows the process steps for a process suitable for manufacturing porous ceramic bodies of this invention;

FIG. 3 is a drawing of a testing apparatus to determine a pellet's crush strength; and

FIG. 4 is a graph of pore size distributions.

### DETAILED DESCRIPTION OF THE INVENTION

Formed, porous ceramic bodies are used in a wide variety of chemical processes such as catalytic applications and adsorption/desorption applications. The use of a plurality of ceramic bodies to act as a substrate, also known herein as a carrier, for a catalytically active material is well known. However, porous ceramic bodies of this invention may be used as a catalyst in some chemical processes without a layer of catalytically active material deposited thereon. The desired physical characteristics of the carrier, such as surface area, crush strength and total pore volume, are significantly impacted by and/or determined by the conditions and requirements of the industrial process in which the carrier will be used. The starting material used to manufacture the carrier, such as alumina, zirconia or titania, inherently affect the properties of the carrier. As shown by the teachings in the documents identified above, specific carriers made of zirconia are known. However, carriers made of zirconia have not been widely used in some catalytic applications because of tradeoffs between crush strength, surface area, pore volume and pore size distribution that have been symptomatic of conventional zirconia carriers which prefer to convert to and/or stabilize as a low surface area monoclinic crystalline phase rather than the less stable but higher surface area tetragonal crystalline phase. According to conventional teachings, the total pore volume and/or average pore size of known zirconia carriers must be reduced if the crush strength of the carrier is increased. Unfortunately, as the total pore volume is reduced and the average pore size is held constant, the carrier's surface area will be reduced. Similarly, if the total pore volume is held constant and the average pore size is increased, the surface area is also reduced. If total pore volume and average pore size are both reduced, the surface area may be reduced. The reduction in surface area limits the amount of catalytic material that can be deposited onto the carrier which negatively impacts the efficiency of the catalyst. Conversely, if the total pore volume and average pore size are increased, the carrier's crush strength may fall below an acceptable level. Despite these apparent and conventionally accepted limitations, the inventors have discovered how to manufacture a formed, porous ceramic body, particularly a carrier for catalytic material, which provides superior crush strength and provides adequate surface area via the incorporation of mesopores within the carrier. Furthermore, the incorporation of mesopores facilitates the diffusion of reactants and products into and out of the mesopores which aids the catalyst's selectivity. As used herein, mesopores are defined as pores with a diameter between 5 nm and 50 nm. Due to the increase in total pore volume, which may be attributable to the incorporation of the mesopores, the carrier's surface area is large enough to facilitate the deposition of a sufficient quantity of catalytic material. Furthermore, the mesopores reduce transfer resistance within the carrier which may be desirable.

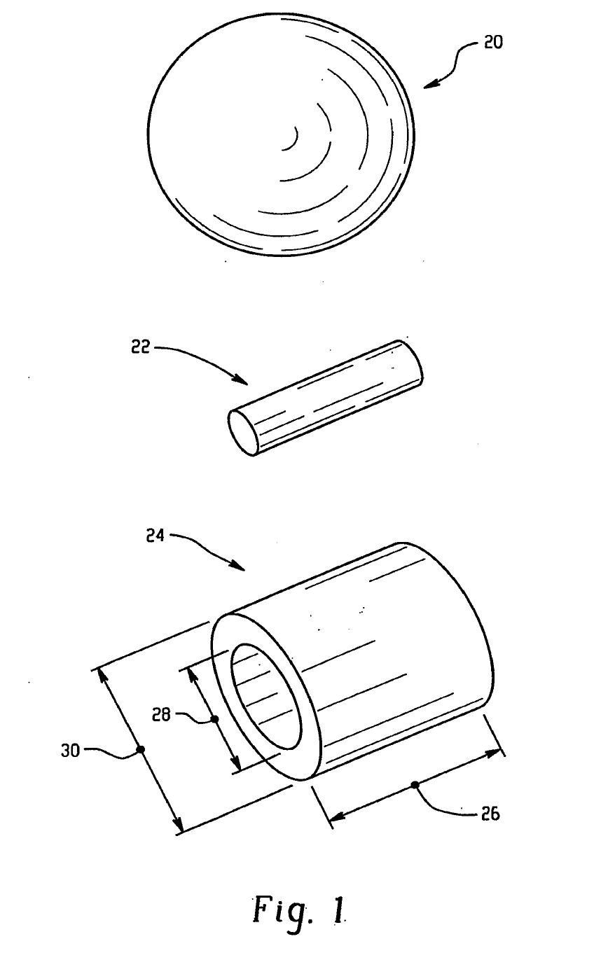

Shown in FIG. 1 are three examples of formed, porous ceramic bodies. First shape 20 is a generally spherical body. Second shape 22 is a rod shaped pellet. Third shape 24 is a tubularly shaped body, also known as a ring, which has a length 26, a generally constant inside diameter 28 and a generally constant outside diameter 30. Any shape may be used that provides the desired crush strength, attrition resistance, pressure drop, and/or other properties for a given application. Processes used to produce the formed ceramic bodies of this invention include any process adapted to the formation of ceramic bodies from powders, such as extrusion, pressing, pan agglomeration, oil drop and spray drying.

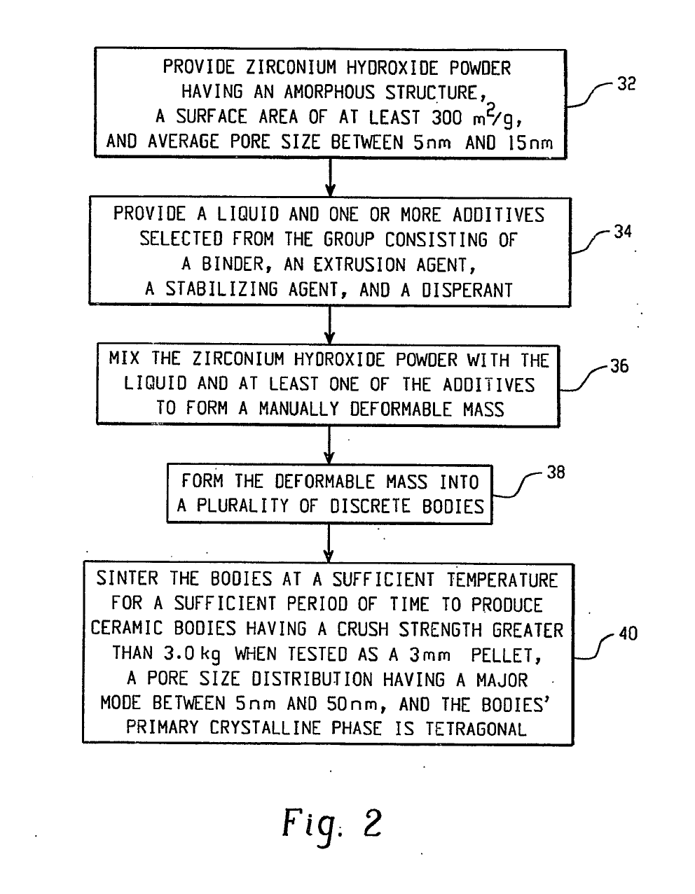

FIG. 2 discloses an example of a process that may be used to produce a porous ceramic body of this invention. Step 32 represents providing a zirconium hydroxide powder that has the following physical characteristics: an amorphous structure, a surface area of at least 300 m²/g and an average pore size between 5 nm and 15 nm. “Surface area” as used herein is understood to relate to the surface area as determined by the B.E.T. (Brunauer-Emmet-Teller) method as described in Journal of American Chemical Society 60 (1938) pp. 309-316. The surface area was determined using a model TriStar 3000 analyzer made by Micromeritics after outgassing the sample for two hours at 250° C. Step 34 entails providing a liquid and one or more additives from the following categories of additives: a binder; an extrusion agent; a stabilizing agent; and a dispersant. If desired, more than one additive from a single category, such as more than one binder and/or more than one dispersant, may be selected. The number, quantity and exact composition of an additive are partially determined by the process used to manufacture the discreet bodies. For example, the addition of an extrusion agent may be omitted if the body is not formed by an extrusion process. As disclosed in step 36, the zirconium hydroxide powder may be mixed with the liquid and one or more of the additives to form a manually deformable mass, which may also be described as a dough. Step 38 represents forming the deformable mass into a plurality of discreet bodies. Step 40 represents the sintering of the bodies at a sufficient temperature and for a sufficient period of time to produce ceramic bodies having the following characteristics: a crush strength greater than 3.0 kg when tested as a 3 mm pellet; a pore size distribution having a major mode between 5 nm and 50 nm; and the bodies' primary crystalline phase is tetragonal. While the time and temperature at which the sintering takes place may be adjusted to accommodate variations in the raw materials, the shape and/or physical dimensions of the discreet bodies, and/or the formula used to produce the dry mixture, the formed porous ceramic bodies of this invention that are disclosed in FIG. 1 are typically sintered between 450° C. and 650° C., such as at 500° C., 550° C., or 600° C., for at least 3 hours. The sintering temperature may be reached by increasing the temperature at a rate of 1° C. to 5° C. per minute from room temperature to the sintering temperature.

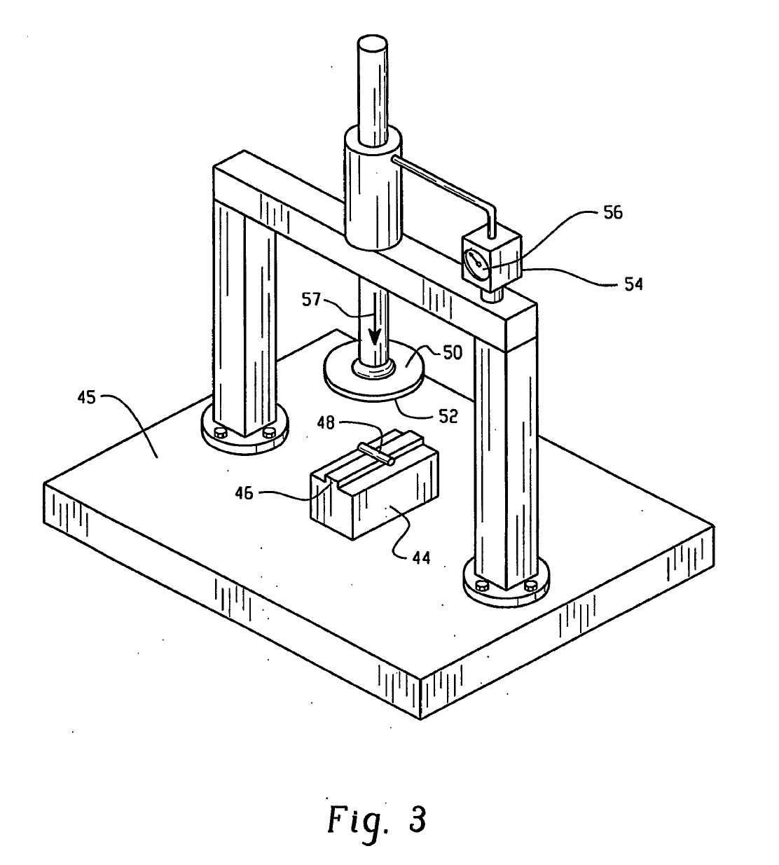

An embodiment of a formed, porous ceramic body of this invention that may be used as a carrier for a catalyst has a crush strength of at least 3.0 kg when tested as a 3 mm pellet. While a 3.0 kg crush strength may be acceptable, higher crush strengths, such as 6.0 kg, 9.0 kg and 12.0 kg may be preferred for particular applications. The pellet is an elongated, cylindrically shaped body that is 3 mm in diameter and 6 to 10 mm in length. With reference to FIG. 3, the crush strength of a pellet is determined as follows. Begin by placing steel block 44, also known as an anvil, on a solid and level surface 45 such as the top of a workbench. A suitable anvil measures 2.0 cm wide by 2.0 cm deep by 4.0 cm long. One of the block's surfaces that measures 2.0 cm by 4.0 cm contains a raised platform 46 which is 0.6 cm wide, 0.3 cm high and extends the length of the steel block's surface. Pellet 48 is placed on the raised platform so that the length of the pellet is perpendicular to the raised portion of the anvil and parallel to the surface of the workbench. Movable platen 50 has a flat surface 52 that measures approximately 3.5 cm in diameter and is oriented parallel to the surface of the workbench and is positioned directly above the anvil onto which the pellet has been placed. The platen is equipped with a load cell 54 that measures the pressure exerted by the platen. Pressure recording device 56 is connected to the load cell. A pellet's crush strength is determined by the operator activating the testing apparatus thereby causing the platen to travel downwardly, see arrow 57, toward the pellet at a rate of 1.2 cm per minute until the platen contacts and then crushes the pellet across the raised platform. The load cell and recording device cooperate to detect and record the pressure exerted on the pellet during the crushing action. If a formed, porous ceramic body is not shaped as a pellet, the crush strength of the ceramic body may be determined by obtaining the raw materials used to make the ceramic body, then forming a pellet and using the test procedure described above. Since the crush strength values are influenced by the shape and size of the ceramic body when it is crushed, the only body that should be crushed is an elongated pellet that measures 3 mm in diameter and 6 mm to 10 mm in length. To determine the average crush strength of a plurality of pellets, measure the crush strength of twenty separate, randomly-selected pellets and then calculate their average value.

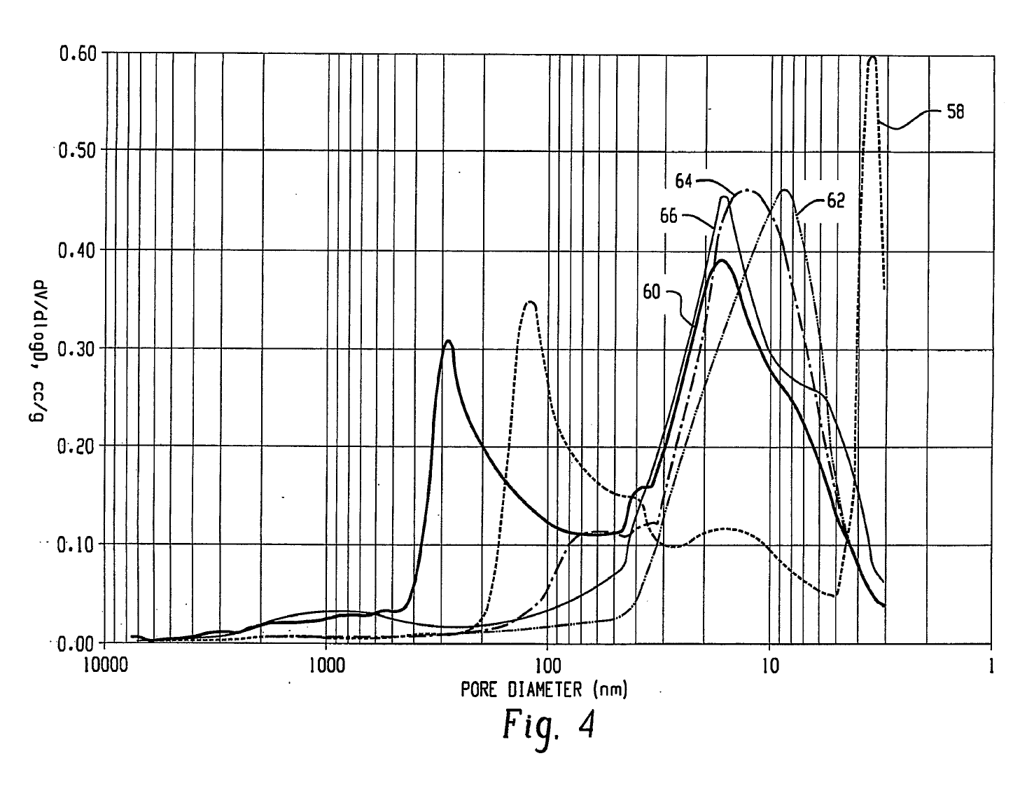

FIG. 4 is a graph which shows the distributions of pore diameters for five different groups of porous bodies formed of tetragonal zirconia. Each distribution has at least a major mode and may have one or more minor modes. A major mode may be defined as the upwardly projecting portion of a particular distribution that has the greatest value on the graph's vertical axis. The apex of the mode is the peak of the mode. A minor mode's upwardly projecting portion has a maximum value on the graph's vertical axis that is less than the major mode's maximum value on the vertical axis. Line 58 represents a distribution of pore diameters found in conventional formed porous bodies made of tetragonal zirconia. Line 60 shows a distribution of pore diameters in formed porous bodies according to a first embodiment of this invention. Line 62 shows a distribution of pore diameters in formed porous bodies according to a second embodiment of this invention. Line 64 shows a distribution of pore diameters in formed porous bodies according to a third embodiment of this invention. Line 66 shows a distribution of pore diameters in formed porous bodies according to a fourth embodiment of this invention. The distribution of pore diameters within formed porous bodies according to a first embodiment of this invention, represented by line 60, has a major mode which peaks at 17 nm and a total pore volume of 0.44 ml/g. A minor mode, which may also be described herein as a second mode, peaks at approximately 291 nm. Line 62, which represents the pore size distribution of a second embodiment of this invention, has a major mode which peaks at 9 nm and a total pore volume of 0.30 ml/g. Line 64, which represents the pore size distribution of a third embodiment of this invention, has a major mode which peaks at 13 nm and a total pore volume of 0.35 ml/g. Line 66, which represents the pore size distribution of a fourth embodiment of this invention, has a major mode which peaks at 17 nm and a total pore volume of 0.36 ml/g. Based on the data available from determining the distribution of pore diameters, the pores having diameters in the range of 5 nm to 50 nm were determined to account for 56%, 91%, 83% and 80% of the total pore volume for the first, second, third and fourth embodiments, respectively. While the percentage of total pore volume attributable to pores having diameters in the range of 5 nm to 50 nm may be as low as 40%, higher percentages, such as 50%, 65% or 80%, are desirable. In contrast, the distribution of pore diameters of conventional formed bodies, represented by line 58, has a major mode which peaks between 3 nm and 4 nm and the total pore volume is 0.32 ml/g. A minor mode peaks between 100 nm and 200 nm. In the formed porous bodies of this invention, the intentional incorporation of mesopores, which were previously defined as pores with a diameter between 5 nm and 50 nm, increases the total pore volume of the formed bodies with limited effect on crush strength. While formed bodies having a pore diameter distribution with a major mode which peaks between 5 nm and 50 nm are acceptable, in particular embodiments, ceramic bodies of this invention have a pore diameter distribution with a major mode which peaks between 5 nm and 30 nm and a second mode which peaks above 70 nm. In one embodiment, the distribution has a major mode which peaks between 8 nm and 25 nm. In one embodiment, a total pore volume of a formed body of this invention is at least 0.30 ml/g. In another embodiment, a total pore volume is at least 0.37 ml/g. The average pore size and total pore volume were determined using mercury porosimetry. The equipment used to characterize pore size distribution and total pore volume was an AutoPore IV made by Micromeritics which utilized software 9500, version 1.07.

For a given pore size distribution, increases in the total pore volume cause a corresponding increase in the formed body's surface area. In one embodiment of this invention, the ceramic body's surface area may be at least 75 m²/g. In another embodiment, the surface area may be at least 100 m²/g.

Formed ceramic bodies of this invention may be made of zirconia in which the primary crystalline phase is tetragonal. As used herein, the phrase “zirconia's primary crystalline phase” is defined to mean the crystalline phase, such as tetragonal or monoclinic, which is at least 50 weight percent of the zirconia's total crystalline phase. The crystalline phase is determined using a Philips X-ray Diffractometer which utilizes Philips X'Pert software and is equipped with a high efficiency X'Celerator detector. The scan range is 10-80 degrees 2 theta and the step size is 0.167 degrees 2 theta. The weight percent of the tetragonal crystalline phase is determined by: (a) measuring the intensity at a d-spacing of 2.96 angstroms which is the tetragonal ZrO₂ peak; (b) measuring the intensities at a d-spacing of 3.16 angstroms and 2.84 angstroms which are the monoclinic ZrO₂ peaks; and then (c) dividing the intensity of the tetragonal peak by the sum of the intensities of the monoclinic peaks and the tetragonal peak. The intensity is determined by measuring the peak height (cps) and then subtracting out the background which is determined using the Treatment/Determine Background/Manual/Subtract options in the X'Pert software. The weight percent of the zirconia's crystalline phase is determined after the ceramic body has been sintered and allowed to cool to room temperature, which is defined as 22° C. If a portion of the zirconia is amorphous, the amorphous portion is not considered when calculating the weight percent of the zirconia's primary crystalline phase. In one embodiment, at least 50 weight percent of the zirconia's crystalline phase is tetragonal. In another embodiment, least 55 weight percent of the zirconia's crystalline phase is tetragonal. In yet another embodiment, at least 60 weight percent of the zirconia's crystalline phase is tetragonal. The existence of a tetragonal crystalline phase increases the surface area of the formed body relative to a similarly formed body made primarily of monoclinic zirconia. As the percentage of tetragonal phase increases from 50 to 60 or 80 or even 100 weight percent, the surface area of the formed body increases. The increase in surface area may be an important parameter which may be increased to improve the performance of a ceramic body when used as a carrier for a catalytically active material.

The thermal stability of the zirconia's tetragonal phase may influence the marketability of a ceramic body of this invention. Conventional ceramic bodies having primarily a tetragonal crystalline phase without a stabilizer incorporated therein are known to readily convert either entirely or substantially to a monoclinic crystalline phase when exposed to the high temperatures that ceramic bodies typically encounter in industrial processes. The conversion from a tetragonal crystalline phase to a monoclinic crystalline phase may not be desired because of the inherent reduction in the crush strength and surface area of the ceramic body that occurs simultaneously with the conversion to the monoclinic phase.

An embodiment of this invention may be a stable ceramic body having primarily a tetragonal crystalline phase. As used herein, the phrase “stable zirconia” means a ceramic body made of zirconia wherein the changes to the ceramic body's surface area, total pore volume and primary crystalline phase caused by heating the ceramic body to 700° C. for fifteen hours are within the following parameters. Relative to the ceramic body's initial surface area, total pore volume and crystalline phase, which are determined after sintering and before heating to 700° C., heating the ceramic body to 700° C. for fifteen hours causes less than a 50% reduction in the surface area, the total pore volume is reduced less than 30%, and the primary crystalline phase is not changed.

The stability of the tetragonal crystalline phase may be improved by the addition of one or more stabilizers such as: silicon oxide, yttrium oxide; lanthanum oxide; tungsten oxide; magnesium oxide, calcium oxide or cerium oxide. In contrast to a conventional zirconia ceramic body that typically incorporates 15 to 20 weight percent silica or alumina in the ingredients used to make the carrier, such that the silica or alumina acts as a binder and/or forms an interconnecting network within the carrier, the quantity of silica used to make a ceramic body of this invention may be less than 10 weight percent, such as less than 5 weight percent, or even 2 weight percent, of the total weight of zirconium hydroxide powder, liquid and at least one additive used to make the deformable mass. The relatively low quantity of silica may limit the silica's role to stabilizing the tetragonal phase rather. than forming an interconnecting network within the carrier. Instead of adding the stabilizer as a separate ingredient to the ingredients during the ceramic body's manufacturing process, the stabilizer may be incorporated into the zirconium hydroxide powder manufacturing process using, for example, a co-precipitation technique, thereby allowing the stabilizer to be directly incorporated into the zirconium hydroxide powder. Incorporating the stabilizer into the zirconium hydroxide powder manufacturing process facilitates the uniform distribution of the stabilizer within the zirconium hydroxide powder. Otherwise, if the stabilizer is added separately care may be taken to insure that the relatively small quantity of stabilizer is properly distributed during the mixing procedure.

To produce a catalyst for use in a chemical reactor, a thin layer of a catalytically active material may be deposited onto the surface of a ceramic carrier body of this invention. The catalytically active material may be selected from the group consisting of at least one element of main group I or II, an element of transition group III, an element of transition group VIII, of the Periodic Table of the Elements, lanthanum and tin.

Four embodiments of a formed, porous ceramic carrier of this invention were produced as follows.

### EXAMPLE A

A quantity of zirconium hydroxide powder, obtained from MEL Chemicals of Manchester, England and designated XZ01501/06, was placed into a mixer. The powder had the following physical characteristics: an amorphous structure, which was determined by X-ray diffraction analysis; a BET surface area of 339 m²/g, which was determined after outgassing the sample for two hours at 250° C; a total pore volume of 0.49 cc/g; a 7.3 nm average pore size; and a particle size distribution wherein D₁₀ was 1.6μ, D₅₀ was 3.5μ, and D₉₀ was 8.5μ. A model TriStar 3000 analyzer was used to determine the BET surface area and average pore size. The following ingredients were added to the zirconium hydroxide powder wherein all percentages are based on the weight of the powder: 1.2 weight percent of Cellosize QP 100 MH, from DOW Chemical Company of Midland, Mich., USA, which is an organic binder; and 1.2 weight percent polyethylene oxide extrusion aid from DOW Chemical Company. The hydroxide powder, organic binder and extrusion aid were dry mixed with one another for one to two minutes to form a dry mixture. The following ingredients were then added to the dry mixture: 31.4 weight % Nalco 2326 which is a silica stabilizer from Nalco Company of Naperville, Ill., USA; 16.6 weight % Bacote 20, which is an inorganic binder from MEI of Flemington, N.J., USA; 0.8 weight % of a 30 weight % NH₄OH aqueous solution which is an inorganic basic dispersant; 1.7 weight % Dispex A-40 from Ciba Specialty Chemicals Corp. of Tarrytown, N.Y., USA, which is an organic dispersant; and 70.4 weight % water. A manually deformable mass, also known as a dough, was created by mixing the dry blended ingredients with the water, silica stabilizer, inorganic binder, inorganic dispersant and organic dispersant. The mixing was continued until the dough had the correct consistency to facilitate extrusion. An extruder was used to produce extrudates, known as greenware and referred to above as pellets, having a diameter of 4.2 mm and lengths that ranged from 3 mm to 10 mm. The pellets were: dried overnight in air; then dried overnight at 80° C. to 110° C. and then sintered at 450° C. to 600° C. The pellets were sintered by slowly increasing the temperature of the sintering furnace at the rate of 1° C. to 5° C. per minute. After sintering, the diameter of the pellets was 3 mm. Physical characterization of the pore diameters showed a major mode with a peak at 17 nm, and a minor mode with a peak at 291 nm. See reference number 60 in FIG. 4. The total pore volume of the extrudates was 0.44 ml/g and the flat plate crush strength was 8.2 kg. The surface area was 123 m²/g. X-ray diffraction analysis showed that 68 weight % of the extrudates crystalline phase was tetragonal and 32 weight % was monoclinic. After heating the pellets to 700° C. for fifteen hours and then allowing them to cool to room temperature, the pellets crystalline phases were 58 weight percent tetragonal and 42 weight percent monoclinic. The surface area had been reduced by 35% and the total pore volume had been reduced by 18%.

### EXAMPLE B

Another embodiment of a formed, porous ceramic carrier of this invention was produced as follows. Using the same ingredients as described in example A, all of the ingredients except the Cellosize QP 100 MH and polyethylene oxide extrusion aid were mixed to form a manually deformable mass. The Cellosize and polyethylene oxide were then added and the mixing was continued to uniformly distribute all of the ingredients into the mass. Sintered pellets formed from this mass were characterized as follows. The pore size distribution had a major mode with a peak at 9 nm. See reference number 62 in FIG. 4. The total pore volume of the extrudates was 0.30 cc/g and the flat plate crush strength was 12.2 kg. The surface area was 129 m²/g. X-ray diffraction analysis showed that 61 weight % of the extrudates crystalline phase was tetragonal and 39 weight % was monoclinic. After heating the pellets to 700° C. for fifteen hours and then allowing them to cool to room temperature, the pellets' primary crystalline phase was 50 weight percent tetragonal, the surface area had been reduced by 33% and the total pore volume had been reduced by 20%.

### EXAMPLE C

Another embodiment of a formed, porous ceramic carrier of this invention was produced as follows. Using the same ingredients as described in example A, the zirconium hydroxide powder, polyethylene oxide and Cellosize QP 100 MH were mixed to form a dry mixture. The water and Nalco 2326 were-premixed with one another to form a solution which was then added to the dry mixture to form a manually deformable mass. While mixing the mass, the Bacote 20, which is a 30 weight % NH₄OH aqueous solution, and the Dispex A-40 were added thereby forming material which was extruded and sintered. Sintered pellets formed from this mass were characterized as follows. The pore size distribution had a major mode with a peak at 13 nm. See line 64 in FIG. 4. The total pore volume of the extrudates was 0.35 ml/g and the flat plate crush strength was 11.9 kg. The surface area was 125 m²/g. X-ray diffraction analysis showed that 61 weight % of the extrudates crystalline phase was tetragonal and 39 weight % was monoclinic. After heating the pellets to 700° C. for fifteen hours and then allowing them to cool to room temperature, the pellets' primary crystalline phase was still tetragonal, the surface area had been reduced by 31% and the total pore volume had been reduced by 20%.

### EXAMPLE D

Another embodiment of a formed, porous ceramic carrier of this invention was produced as follows. A quantity of zirconium hydroxide powder, obtained from MEL Chemicals of Manchester, England and designated XZO1662/01, was placed into a mixer. In contrast to the zirconium hydroxide used in examples A to C, the zirconium hydroxide powder used in example D contained 4 weight percent silica which had been deposited by a co-precipitation technique. As previously explained, the silica may improve the stability of the carrier's microcrystalline tetragonal phase. Since the silica was directly incorporated in the zirconium hydroxide, Nalco 2326 was not included in this mix as had been done in previous examples. The powder had the following physical characteristics: an amorphous structure, which was determined by X-ray diffraction analysis; a BET surface area of 388 m²/g, which was determined after outgassing the sample for two hours at 250° C.; a total pore volume of 0.76 cc/g; a 8.7 nm average pore size; and a particle size distribution wherein D₁₀ was 1.8μ, D₅₀ was 3.8μ, and D₉₀ was 7.2μ. The following ingredients were added to the zirconium hydroxide powder wherein all percentages are based on the weight of the powder: 1.2 weight percent of Cellosize QP 100 MH; and 1.2 weight percent polyethylene oxide. The hydroxide powder, organic binder and extrusion aid were dry mixed with one another for one to two minutes to form a dry mixture. The following ingredients were then added to the dry mixture: 16.6 weight % Bacote 20; 0.8 weight % of a 30 weight % NH₄OH aqueous solution; and 1.7 weight % Dispex A-40. A manually deformable mass was created by mixing the dry blended ingredients with the water, inorganic binder, inorganic dispersant and organic dispersant. The mixing was continued until the dough had the correct consistency to facilitate extrusion. An extruder was used to produce extrudates, known as greenware and referred to above as pellets, having a diameter of 4.2 mm and lengths that ranged from 3 mm to 10 mm. The pellets were then dried and sintered as described in example A. After sintering, the diameter of the pellets was 3 nm. Physical characterization of the pore diameters showed a major mode with a peak at 17 nm. See reference number 66 in FIG. 4. The total pore volume of the extrudates was 0.36 ml/g and the flat plate crush strength was 7.4 kg. The surface area was 157 m²/g. X-ray diffraction analysis showed that 100 weight % of the extrudates crystalline phase was tetragonal. After heating the pellets to 700° C. for fifteen hours and then allowing them to cool to room temperature, the pellets crystalline phases were 82 weight percent tetragonal. The surface area had been reduced by 31% and the total pore volume had been reduced by 8%.

The above description may be considered that of examples of embodiments only. Modifications of the invention will occur to those skilled in the art and to those who make or use the invention. Therefore, it is understood that the embodiments shown in the drawings and described above are merely for illustrative purposes and are not intended to limit the scope of the invention, which is defined by the following claims as interpreted according to the principles of patent law.

We claim:

1. A formed, porous ceramic body comprising zirconia, said body having a crush strength greater than 3.0 kg when tested as a 3 mm pellet; a pore size distribution having at least one major mode which peaks between 5 nm and 50 nm; and said zirconia's primary crystalline phase is tetragonal.

2. The ceramic body of claim 1, wherein at least 50 weight percent of said zirconia's crystalline phase is tetragonal.

3. The ceramic body of claim 2, wherein at least 55 weight percent of said zirconia's crystalline phase is tetragonal.

4. The ceramic body of claim 3, wherein at least 60 weight percent of said zirconia's crystalline phase is tetragonal.

5. The ceramic body of claim 1 having a crush strength greater than 6.0 kg.

6. The ceramic body of claim 5 wherein said crush strength exceeds 9.0 kg.

7. The ceramic body of claim 6 wherein said crush strength exceeds 12.0 kg.

8. The ceramic body of claim 1, wherein said pore size distribution further comprises a second mode having a peak greater than 70 nm.

9. The ceramic body of claim 1 having said major mode's peak between 5 nm and 30 nm.

10. The ceramic body of claim 9 wherein said major mode peaks between 8 nm and 25 nm.

11. The ceramic body of claim 1, wherein said body has a total pore volume greater than 0.30 ml/g.

12. The ceramic body of claim 11, wherein said body has a total pore volume greater than 0.37 ml/g.

13. The ceramic body of claim 11, wherein pores having diameters in the range of 5 nm to 50 nm represent at least 40% of the total pore volume.

14. The ceramic body of claim 13, wherein pores having diameters in the range of 5 nm to 50 nm represent at least 50% of the total pore.

15. The ceramic body of claim 14, wherein pores having diameters in the range of 5 nm to 50 nm represent at least 65% of the total pore volume.

16. The ceramic body of claim 1, wherein said body further comprises a layer of catalytically active material deposited onto the body.

17. The ceramic body of claim 16, wherein said catalytically active material is selected from the group consisting of at least one element of main group I or II, an element of transition group III, an element of transition group VIII, of the Periodic Table of the Elements, lanthanum and tin.

18. The ceramic body of claim 1 having a surface area greater than 75 m²/g.

19. The ceramic body of claim 18 having a surface area greater than 100 m²/g.

20. A process, for making a plurality of porous ceramic bodies comprising zirconia, comprising the steps of:
(a) providing a zirconium hydroxide powder having an amorphous structure, a surface area of at least 300 m²/g, and average pore size between 5 nm and 15 nm;
(b) providing a liquid and one or more additives selected from the group consisting of a binder, an extrusion agent, a stabilizing agent, and a dispersant;
(c) mixing said zirconium hydroxide powder with said liquid and at least one of said additives to form a manually deformable mass;
(d) forming said deformable mass into a plurality of discreet bodies; and
(e) sintering said bodies at a sufficient temperature for a sufficient period of time to produce ceramic bodies having an average crush strength greater than 3.0 kg when tested as a 3 mm pellet, a pore size distribution having at least one major mode which peaks between 5 nm and 50 nm, and said zirconia's primary crystalline phase is tetragonal.

21. The process of claim 20, wherein said bodies have an average crush strength greater than 6.0 kg.

22. The process of claim 21, wherein said crush strength exceeds 9.0 kg.

23. The process of claim 22, wherein said crush strength exceeds 12.0 kg.

24. The process of claim 20, wherein at least 50 weight percent of said zirconia's crystalline phase is tetragonal.

25. The process of claim 24, wherein at least 55 weight percent of said zirconia's crystalline phase is tetragonal.

26. The process of claim 25, wherein at least 60 weight percent of said zirconia's crystalline phase is tetragonal.

27. The process of claim 20, further comprising the step of depositing a layer of catalytically active material on the sintered body.

28. The process of claim 27, wherein said catalytically active material is selected from the group consisting of at least one element of main group I or II, an element of transition group III, an element of transition group VIII, of the Periodic Table of the Elements, lanthanum and tin.

29. The process of claim 20, wherein said liquid comprises an aqueous solution.

30. The process of claim 29, wherein said liquid comprises water.

31. The process of claim 20, wherein said forming step comprises one or more of the processes selected from the group consisting of extrusion, spray drying, pan agglomeration, oil dripping and pressing.

32. The process of claim 20, wherein said binder comprises an organic binder.

33. The process of claim 20, wherein said binder comprises an inorganic binder.

34. The process of claim 20, wherein said dispersant comprises a first dispersant and said first dispersant is an organic dispersant.

35. The process of claim 34, wherein said dispersant further comprises a second dispersant and said second dispersant is an inorganic dispersant.

36. The process of claim 20, wherein said sintering step comprises sintering said bodies for at least 3 hours at a temperature of at least 550° C.

37. The process of claim 20, wherein said stabilizing agent is selected from the group consisting of: silicon oxide, yttrium oxide, lanthanum oxide, tungsten oxide, magnesium oxide, calcium oxide and cerium oxide.

38. A process, for making a plurality of porous ceramic bodies comprising zirconia, comprising the steps of:
(a) providing a zirconium hydroxide powder comprising a stabilizing agent, said powder having an amorphous structure, a surface area of at least 300 m²/g, and average pore size between 5 nm and 15 nm;
(b) providing a liquid and one or more additives selected from the group consisting of a binder, an extrusion agent, and a dispersant;
(c) mixing said zirconium hydroxide powder with said liquid and at least one of said additives to form a manually deformable mass;
(d) forming said deformable mass into a plurality of discrete bodies; and
(e) sintering said bodies at a sufficient temperature for a sufficient period of time to produce ceramic bodies having an average crush strength greater than 3.0 kg when tested as a 3 mm pellet, a pore size distribution having at least one major mode which peaks between 5 nm and 50 nm, and said zirconia's primary crystalline phase is tetragonal.

39. The process of claim 38, wherein said zirconium hydroxide powder comprises a stabilizing agent deposited via a co-precipitation technique.

40. The stabilizing agent of process of claim 38 selected from the group consisting of silicon oxide, yttrium oxide; lanthanum oxide; tungsten oxide; magnesium oxide, calcium oxide or cerium oxide.

41. The process of claim 38, wherein said stabilizing agent represents less than 10 weight percent of the total weight of said zirconium hydroxide powder, liquid and at least one additive.

42. The process of claim 41, wherein said stabilizing agent represents less than 5 weight percent of the total weight of said zirconium hydroxide powder, liquid and at least one additive.

43. The process of claim 42, wherein said stabilizing agent represents less than 2 weight percent of the total weight of said zirconium hydroxide powder, liquid and at least one additive.
